(19) United States
(12) Patent Application Publication
(10) Pub. No.: US 2008/0230624 A1
(43) Pub. Date: Sep. 25, 2008

(54) ELECTRONIC ACTUATOR FOR SIMULTANEOUS LIQUID FLOWRATE AND PRESSURE CONTROL OF SPRAYERS

(75) Inventors: Durham K. Giles, Davis, CA (US); Duane Needham, Walnut Creek, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 12/048,159

(22) Filed: Mar. 13, 2008

Related U.S. Application Data
(60) Provisional application No. 60/894,562, filed on Mar. 13, 2007.

(51) Int. Cl. B05B 12/00; F16K 31/06

(52) U.S. Cl. 239/69; 239/101; 700/283

(57) ABSTRACT

An electric solenoid valve and electronic circuitry for actuating the valve in such a manner as to control the liquid flow into a device, such as a spray nozzle, is described. By altering the characteristics of the electrical signal driving the valve, the flowrate of liquid through the valve and the pressure drop across the valve during the instantaneous flow can be controlled with a single actuator. The complex waveform of the solenoid drive signal allows decoupled control of droplet size and average flow rate through the nozzle.

### CROSS-REFERENCE TO RELATED APPLICATIONS

This application claims priority from U.S. provisional application Ser. No. 60/894,562 filed on Mar. 13, 2007, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to liquid sprayer systems and more particularly to control of the flowrate of liquid through solenoid actuated nozzle valves and the control of pressure drop across the valves during instantaneous flow in order to provide predictable and controllable droplet sizes, flowrate dispersion density and spray area for each nozzle with a single actuator.

2. Description of Related Art

Modern agriculture is becoming increasingly dependent on the efficient and accurate application of liquid fertilizers and crop protection agents in order to be profitable and environmentally responsible. Agricultural chemicals may be applied as sprays of liquid solutions, emulsions or suspensions from a variety of delivery systems. Typical systems pressurize liquid from a reservoir and atomize a liquid stream into droplets through a nozzle. Nozzles may be selected to provide a range of droplet sizes, spray distribution patterns and flow rates for a desired liquid material application. Spray distribution, droplet size, droplet velocity and flow rate are important considerations in field applications. Ideally, sprays of properly sized droplets will produce uniform coverage of material over the vegetation, the ground or other substrate. Spray distribution is the uniformity of coverage and the pattern and size of the spray area, including the overlap of spray patterns between nozzles. Poor spray distribution can limit the efficacy of an application and may lead to adverse environmental injuries, poor crop yields and increased costs.

The size of the spray droplets and application conditions will also influence the substrate coverage and the occurrence of spray drift, where droplets travel to and land outside of the designated spray area. Application conditions such as sprayer height, nozzle type, speed of the sprayer, droplet size, ambient temperature, wind and humidity can contribute to spray drift. Comparatively larger droplets, lower sprayer height and slower sprayer speeds in optimum weather conditions will minimize the occurrence of spray drift. Nozzles that produce droplet sizes for existing spraying conditions may also be selected according to the type of chemical and the type of crop or substrate being sprayed.

Conventional techniques determine a nozzle flow rate that will provide a selected volume of material over the entire field. Flowrate is typically controlled and monitored by a single flowmeter or pressure transducer and a single pressure actuator for selected flow conditions. Normally, the flow rate is changed by changing the fluid pressure of the liquid being fed to the nozzles or bank of nozzles. However, there are a number of disadvantages to this approach. First, the flow rate is proportional to the square root of the pressure. Consequently, large changes in pressure are required to make relatively small flow rate changes. For example, the pressure must increase nine fold in order to increase the flow rate through the nozzle by three fold. Secondly, the spectrum of droplet sizes emitted from the nozzle is very sensitive to the supply pressure, and therefore extremely sensitive to nozzle flow rate. An increase or decrease in fluid pressure will change the droplet size and spray distribution of the nozzle. Maintaining a desired droplet size is often critical for a good spray deposition of an agricultural pesticide. Thirdly, the pattern or spatial distribution of the spray is affected by the liquid pressure. For example, a decrease in pressure will increase the droplet size and will decrease the size of the spray pattern and the overlap of the spray patterns between nozzles. Often, at low liquid pressures the pattern does not fully develop. This can result in incomplete coverage or excess coverage in portions of the same field.

Agricultural sprayer systems typically use booms with many sprayer heads connected to pumps and a liquid reservoir. The systems can be self propelled or towed through the application zones and may have application speeds of twenty miles per hour or more. Booms of 30 meter lengths or greater may have hundreds of spray nozzles. In agricultural spraying, the flow rate through a nozzle is important in order to deliver the specified amount of active ingredient to a designated application area. The proper flow rate is often a function of nozzle spacing and vehicle speed over the ground.

However, while larger booms and faster ground speeds provide greater coverage efficiency, they can also create application errors, such as over-dosing or under-dosing, which can be significant. For example, if the sprayer boom is making a turn around a point at the end of a pass on the edge of a field, the inner nozzles will travel slower than the nozzles at the distal end of the boom. Sharp turns may also cause the inner nozzles to travel backwards over previously sprayed sections. As a result, some areas will receive more material than desired through slower speeds or double applications while other areas could receive less material than desired. There are many other situations where adjusting the droplet size on an individual nozzle is desirable, including use in narrow buffer zones where a smaller droplet size is mandated for mitigating spray drift.

Because the desired flow rate and the desired pressure are derived from different parameters, control of the two independently using a single actuator located at each nozzle would be beneficial to the applicator. Additionally, because agricultural spraying can be a low margin business, and because spray components are typically expensive, independent control of both pressure and flow with a single actuator would be particularly desirable.

Accordingly, there is a need for a system with nozzles that provide uniform spray distribution with individual control over the flow rate, droplet size and dispersion density of spray emitted from each nozzle. The present invention satisfies these needs as well as others and generally overcomes the deficiencies of the art.

### BRIEF SUMMARY OF THE INVENTION

The present invention provides a system and method for controlling, independently and selectively, the spray characteristics of each nozzle in the system and permits position and sensor responsive control of the application of liquid materials. Control of individual nozzles allows for more rapid and sophisticated treatment of field zones that may have different application needs. For example, irregular boundaries create overspray difficulties resulting in either sprays on adjacent land or insufficient applications near the boundary line. Similarly, if the operator inadvertently crosses a field boundary or property line, the output of specific nozzles can be managed to avoid the unintentional application of material.

The selective control of individual nozzles can also associate the application density with the speed of the application vehicle. This will permit a generally uniform application when the vehicle climbs hills, increases or decreases speed or makes turns.

The system is also open to selective actuation of each nozzle by computer programming and in response to sensor input such as Global Positioning System (GPS) positioning data or infra-red sensors etc. Selective control will allow the application density to be automated and varied in response to specific field topography, vehicle speed, changing weather conditions, diseases and pests or zones for improved precision farming.

The present invention provides an electrically actuated variable flow control liquid spraying system with individually controlled pressure-atomization spray nozzles. Each nozzle is attached to a direct acting, in-line solenoid valve which is connected to a liquid supply at a selected constant pressure. The liquid pressure in the common supply may be adjusted using conventional pressure control systems. The solenoid valve is pulsed at frequencies in the range of 3 to 15 Hz and the temporally averaged flowrate is controlled by the pulse duration i.e. duty cycle. Each pulse of the valve results in an emission of spray. By controlling the pressure drop across the solenoid valve during each pulse, the supply pressure of the liquid to the nozzle and the spray droplet size spectrum are controlled.

It has been shown that nozzle flow rate can be accurately manipulated by Pulse Width Modulation (PWM) of the solenoid valve, with the duty cycle of the drive signal being linearly related to the temporally averaged flow rate. Therefore, the supply pressure into the valve can remain constant while the valve actuation can be used to control the flow rate through the nozzle and the pressure supply of the liquid into the nozzle.

It has also been shown that the pressure across a nozzle often regulates the average and distribution of sizes of the droplets being delivered. Since spray droplet size and spray pattern are functions of supply pressure they can be made independent of the flow rate through pulsing for flow control. The flow rate through a valve and the pressure across the valve in steady-state are usually related, where flow is a function of the square root of pressure. However, if the valve is controlled with a complex metering function, average flow rate and instantaneous pressure (droplet size) may be controlled independently and through a single actuator.

Solenoid valves are typically driven to a fully open or a fully closed position upon actuation. Therefore, a square wave pulse driving the valve normally has only two states, (high and low), corresponding to full current flow and no current flow. However, instead of driving the valve to a completely open position on each pulse, the duty cycle of a high frequency modulation signal, ranging from 3 kHz to 15 kHz is used to control the degree of partial valve opening during each brief pulse. By altering the degree of valve opening, the pressure drop across the valve can be controlled during each pulse of flow, and, in turn, the inlet pressure to the spray nozzle can be controlled. This results in each pulse of liquid through the valve and close-coupled nozzle having a controlled duration, to achieve an average flow rate, and also having a controlled pressure, to achieve a desired droplet size spectrum.

For example, in one design, the high state, which is normally a steady voltage, is replaced by a high frequency modulated signal. This modulated open state, coupled with the optional resistance of a poppet spring, serves to hold the poppet in a partially open position for the duration of the modulated pulse and the corresponding flow of liquid through the valve. When a spray nozzle is coupled to the outlet of the valve, the pressure drop across the valve controls the inlet pressure, and consequently, the droplet size spectrum produced by the nozzle during the instantaneous flow associated with the pulse.

In one embodiment, the present invention comprises an electric solenoid valve and electronic circuitry for actuating the valve in such a manner as to control the liquid flow into a device, for example, a spray nozzle. In this embodiment, by altering the characteristics of the electrical signal driving the valve, the flowrate of liquid through the valve and the pressure drop across the valve during the instantaneous flow can be controlled.

In another embodiment, the present invention comprises electronic circuitry configured for generating an electrical signal for actuating an electric solenoid valve in such a manner as to simultaneously and/or instantaneously control the pressure drop across the valve and the rate of liquid flow into an output device.

In another embodiment, the invention comprises a method of altering the characteristics of an electrical signal driving an electric solenoid valve such that flow rate through the valve and pressure drop across the valve are simultaneously and/or instantaneously controlled.

Another embodiment of the invention provides a computer controller that has programming and is responsive to input from sensors, user interface, and other parameters. The programming or manual control of the computer permits the coordinated control of the output of individual nozzles on booms in real time to account for conditions such as sprayer speed and location, variable coverage needs and prevailing spraying conditions.

Furthermore, combining the flow rate actuator and the pressure actuator into a single mechanical unit, placed at each nozzle, allows control of flow and pressure on a much smaller spatial scale than those methods where pressure is controlled for a collection of nozzles. Modulating the pressure during each instantaneous emission of spray from the nozzle allows for more rapid response, further improving the spatial scale and resolution of spray application.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a solenoid valve showing the valve mechanism, spring and liquid pressure forces and flow according to the present invention.

FIG. 2 is a schematic diagram of a pressure throttling mechanism with a poppet and seat of a solenoid valve according to the invention.

FIG. 3 is a schematic diagram of an alternative embodiment of a solenoid valve with a needle valve and seat according to the invention.

FIG. 4 is a graph of a low frequency 10 Hz, 50% duty cycle signal for flow rate control according to the present invention.

FIG. 5 is a graph of a high frequency 10 kHz, 50% duty cycle signal for pressure control according to the present invention.

FIG. 6 is a graph of the combined low frequency flow (10 Hz) and pressure (10 kHz) control signal (time signal distorts high frequency wave).

FIG. 7 is a graph of the pressure control with modulation duty cycle on the high frequency signal shown in FIG. 5.

FIG. 8 is a graph of the output flow control with the low frequency pulse duty cycle.

FIG. 9 is a graph of the voltage data demonstrating ramping outlet pressure over time.

FIG. 10 is a graph of the voltage data demonstrating the outlet pressure over time resulting from a burst signal with a start up period of constant current.

FIG. 11 is a graph of the resulting output pressures between valve and nozzle from modulation of 5 kHz duty cycles over a range of pulse frequencies.

FIG. 12 is a graph of the nozzle pressure versus average droplet size for the 8002 and 8006 nozzles.

FIG. 13 is a graph of the volumetric flow rate from nozzle and nozzle inlet pressure as controlled by burst modulation of the solenoid valve coupled to the 8002 nozzle over various pulse duty cycles.

FIG. 14 is a graph of the volumetric flow rate from nozzle and droplet size as controlled by burst modulation of the solenoid valve coupled to the 8002 nozzle over various pressures.

FIG. 15 is a graph of the correlation between measured flow rate and flowrate predicted from pressure and duty cycle modulation signal for 8002 and 8006 nozzles.

### DETAILED DESCRIPTION OF THE INVENTION

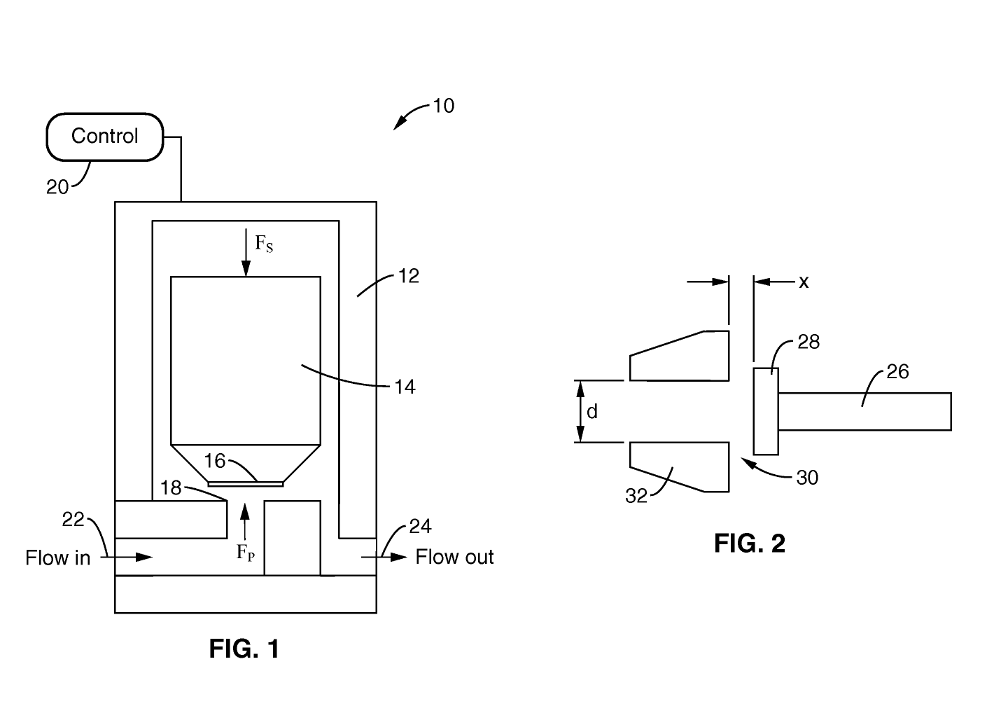

Referring more specifically to the drawings, for illustrative purposes the present invention is embodied in the apparatus and system generally shown in FIG. 1 through FIG. 15. It will be appreciated that the apparatus may vary as to configuration and as to details of the parts, and that the methods may vary as to the specific steps and sequence, without departing from the basic concepts as disclosed herein.

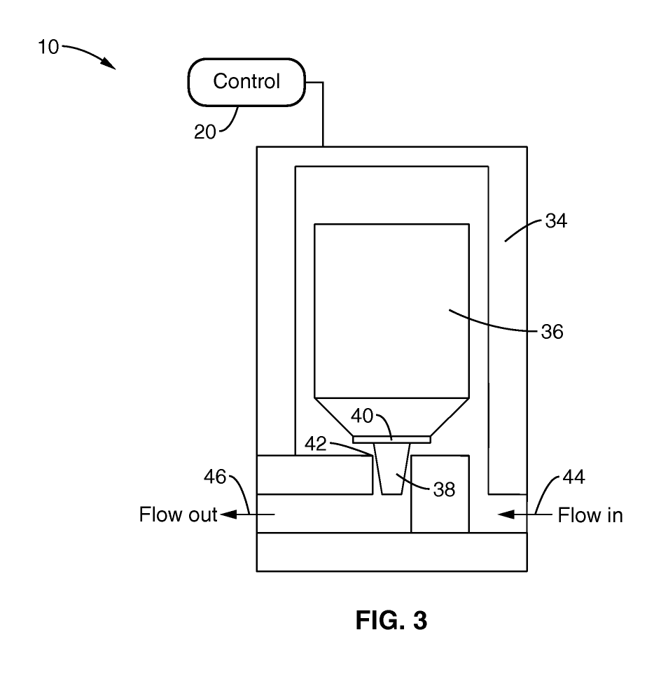

Turning now to FIG. 1 and FIG. 2, a schematic diagram of one embodiment of a solenoid valve 10 according to the invention is generally shown. FIG. 3 is a schematic diagram of an alternative embodiment of a solenoid valve with a poppet/plunger head with a needle valve configuration. The solenoid valve 10 is connected to a nozzle (not shown) from the output flow of the valve. The solenoid valve 10 has a cylindrical body 12 with a poppet/plunger 14 that slides within the interior of the cylindrical body 12 upon the introduction of a magnetic field. The plunger 14 has a seal 16 that matches the orifice 18 to seal and stop the flow of fluid when the poppet seal 16 is engaged with the orifice 18 in the embodiment shown. The solenoid may also have an optional spring or other structure (not shown) to bias the poppet in an open or closed position when the system is not energized. In these embodiments, the plunger 14 and seal 16 may be forced by the spring to engage the orifice 18 in the resting position and drawn away from the orifice 18 when the solenoid is energized. When the magnetic field dissipates, the tension of the spring or other bias member causes the poppet 14 to return to its original position. The force of the spring (Fₛ) opposes the force of the pressure of the liquid (Fₚ) entering the intake port 22 that is exerted on the poppet 14 shown in FIG. 1.

Each solenoid valve 10 is connected to a means for controlling valve actuation. Valve controller 20 of the embodiment shown in FIG. 1 is preferably a computer system that is programmable and will produce valve actuation signals. Controller 20 can optionally be connected to one or more sensors such as position sensors, valve function sensors, speed sensors, and target sensors etc. that provide relevant information to the controller 20 that would influence the flow rate and droplet size of material to be applied. The controller 20 may also have a user interface. In this way the controller 20 can be operated manually or can be automated using programming and sensor data.

Each solenoid valve 10 has an intake port 22 and an output port 24 that is fluidly connected to a nozzle. Fluid from a reservoir of fluid is presented to the intake port 22 under pressure. The pressure of the fluid is preferably maintained at a constant pressure. However, in one embodiment, the pressure of fluid to the intake port 22 could be varied.

Outlet pressure (droplet size) control of the fluid can be accomplished with the poppet/plunger acting as a throttling mechanism as shown schematically in the embodiment of FIG. 2. The moveable plunger/poppet 26 has a head 28 that engages the orifice 30 of the intake port 32. The poppet 26 can form a simple disk throttling valve with the flow area equal to the circumference of the orifice 30 multiplied by the poppet displacement. The throttling mechanism shown in FIG. 2 functions according to the following equation:

A=π·d·x

where A is the area of the controlling orifice, d is the diameter of the intake port 32, and x is the displacement of the poppet.

An alternative embodiment of the solenoid valve design is shown in FIG. 3 that provides a non-leak seal, a wider inlet pressure working range, and a wide outlet pressure control range with wide ranges in flow. The valve embodiment shown schematically in FIG. 3 has a valve body 34 with a coil permitting the controlled movement of poppet/plunger 36. The poppet 36 has a conical shaped tip element 38 and an O-ring seal 40 replacing the standard rubber bumper seal. The O-ring seal 40 engages the orifice 42 to seal the valve when the solenoid is energized or de-energized, depending on whether the valve is designed to be “normally-open” or “normally-closed”, respectively. The valve body 34 also has an intake port 44 that is coupled to a source of pressurized fluid. The fluid can be presented to the intake port at a constant pressure or variable pressures during use. The valve body 34 also has an output port 46 that is connected to a nozzle or other device. The valve is preferably ported in the “forward” direction with enough stroke to open, and then effectively throttle fluid. A controller 20 is operably connected to each valve 10 to characteristically actuate the valve.

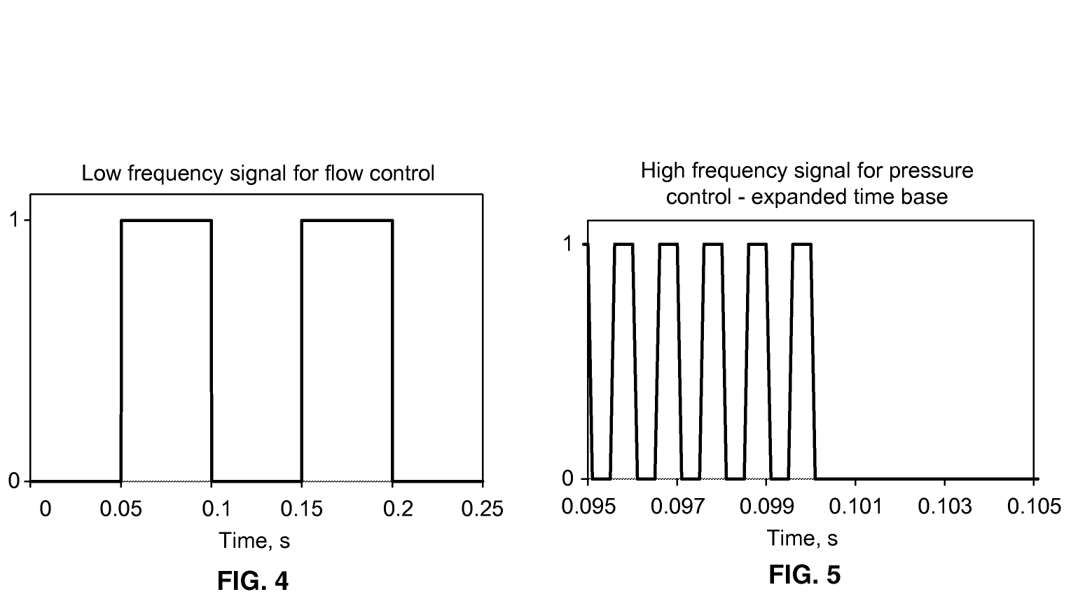

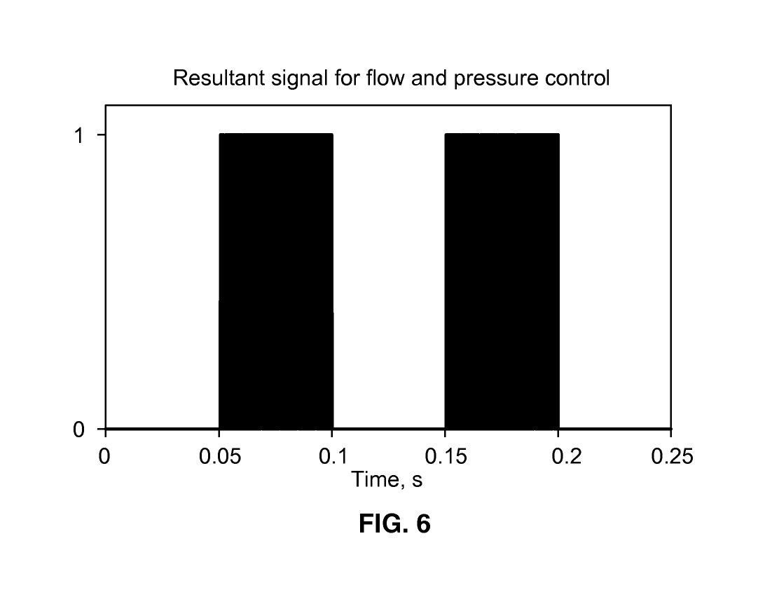

Referring also to FIG. 4, FIG. 5 and FIG. 6, a preferred embodiment of the system described herein employs a modulated square wave from controller 20 to drive solenoid valve 10 to control the pressure and flow of liquid through the nozzle. The duty cycle of the high-frequency modulation is used to throttle a solenoid poppet valve, that is, to control the “x” dimension shown in FIG. 2 to manipulate the outlet pressure. The low-frequency pulse duty cycle is used to meter the average flow rate by enabling/disabling the instantaneous flow rate that resulted from the outlet pressure. Thus, the solenoid drive signal provides for a single-actuator, decoupled control of droplet size (pressure) and average flow rate.

For example, in FIG. 4, the controlling valve actuation signal from controller 20 can be illustrated with the low frequency flow control signal of 10 Hz, 50% duty cycle. The preferred range of the low frequency flow control signal is in the range of approximately 3 Hz to approximately 15 Hz. The 10 Hz signal shown in FIG. 4 would be typical of a pulse width modulation where the valve would be held fully open during the 0.05 to 0.10 second period and fully closed during the 0.10 to 0.150 second period. This would result in a nominal 50% flow rate of liquid from the nozzle. The pressure at the nozzle inlet, P_{N} (located downstream from the valve exit port 24) would be equal to the supply pressure at the valve inlet port 22, P less the pressure drop across the fully open valve, ΔPv, or P_{N}=P−ΔPv. When the valve is fully open, ΔPv is minimized.

However, to achieve simultaneous flow and pressure control, the valve 10 is prevented from fully opening such that the pressure drop across the valve, ΔPv, is increased, resulting in a lower P_{N}. This is done by modulating the “on” time signal of the low frequency pulses. Instead of maintaining the voltage at the constant full level, it is pulsed at a high frequency ranging from approximately 5 kHz to approximately 15 kHz, with 10 kHz being preferred as shown in FIG. 5.

The combined signal for flow and pressure control is the combination of the low frequency flow control and high frequency pressure control signals as shown in FIG. 6.

Accordingly, it can be seen that the flow rate of the nozzle can be controlled by the duty cycle (proportion of “on time” or pulse duration to total i.e. “on time” plus “off time”) and the duty cycle of a high frequency modulation signal can be used to control the degree of partial valve opening during each pulse and consequently the inlet pressure to the spray nozzle. Such control of the flow rate and pressure drop of individual nozzles permits precision spraying that can be responsive to variable conditions and changing circumstances.

The invention may be better understood with reference to the accompanying examples, which are intended for purposes of illustration only and should not be construed as in any sense limiting the scope of the present invention as defined in the claims appended hereto.

### EXAMPLE 1

In order to demonstrate the control of both flowrate and pressure (and corresponding droplet size) through a nozzle, an electric solenoid valve (KIP, Inc. Series 2 valve, 7 W coil) was connected to a liquid (water) reservoir with a constant input pressure of 50 psi. The valve was ported with the pressurized inlet port sealed by the valve poppet as shown schematically in FIG. 1. The outlet was connected with a tee to an Omega PV102-1 OV pressure transducer and to a Spraying Systems 1502 flat fan spray nozzle. An additional spring was added to the valve poppet so that the effective spring constant was doubled.

The valve was ported “backwards” to avoid the avalanche response for which the valve was designed; the valve was designed to open fully with a threshold voltage, and close fully at a threshold voltage. The added spring helped to seal the valve and the inlet pressure was limited to 50 psi. For higher inlet pressures, a stiffer spring and larger coil are required.

The solenoid was powered with a 13.8-volt supply with an NDP6060 FET sinking current to ground. A 1N5817 diode was connected parallel to the solenoid to allow fly-back current to flow with very little impedance. An arbitrary function generator was used to gate the FET with a square-wave burst. The square-wave had a modulation frequency of 10 kHz as illustrated in FIG. 5, a burst count of 500 (for a 50% pulse duty cycle), and a burst frequency of 10 Hz as shown in FIG. 4. The duty cycle of the high frequency modulation was used to partially open or “float” the valve poppet controlling the outlet pressure by adjusting ΔPv. The burst count regulated the low-frequency pulse duty cycle thus controlling the percentage of on-time. With the combination of modulation duty control and low-frequency pulse duty control, outlet pressure and outlet flow rate were controlled with a single actuator signal, as illustrated in FIG. 6 in a valve as illustrated in FIG. 1.

Modulation duty cycle and low-frequency pulse duty cycle were recorded from the settings on the function generator. Output pressure was monitored with the Omega pressure transducer connected to a Tektronix storage oscilloscope. The voltages from the transducer during the on-cycle of the low frequency pulses were recorded. Flow rate was monitored by measuring the time for the 1502 nozzle to output 300 milliliters of water.

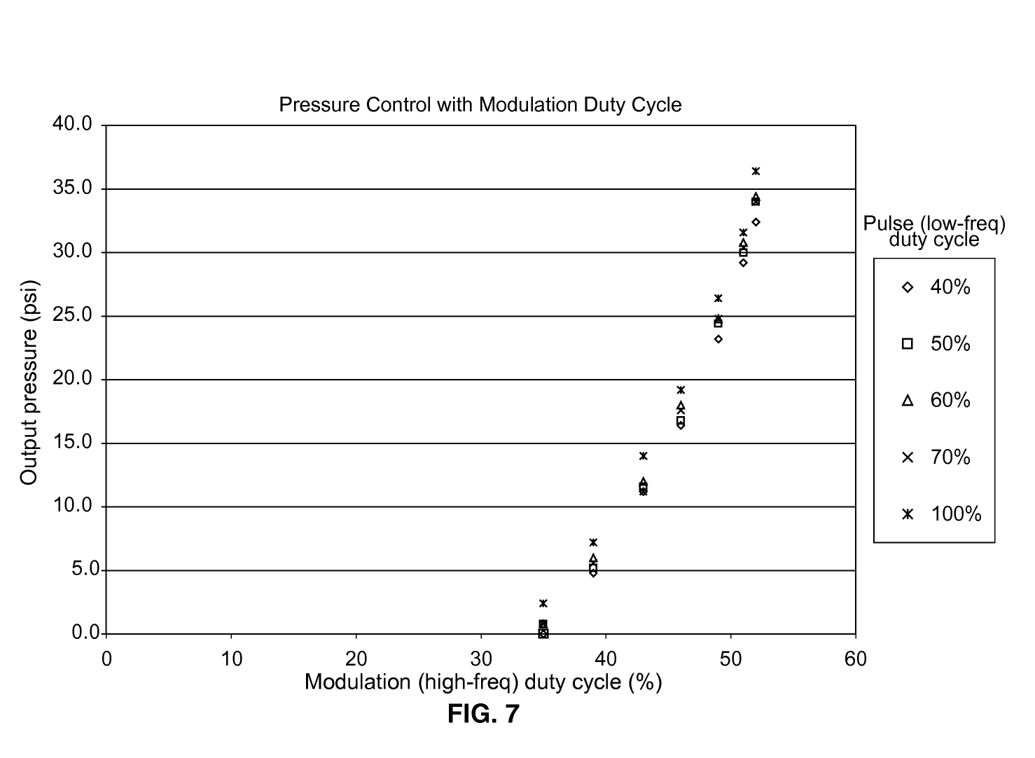

The resulting output pressures from modulation duty cycle control at various low-frequency duty cycles ranging from 40% to 100% were plotted and shown in FIG. 7.

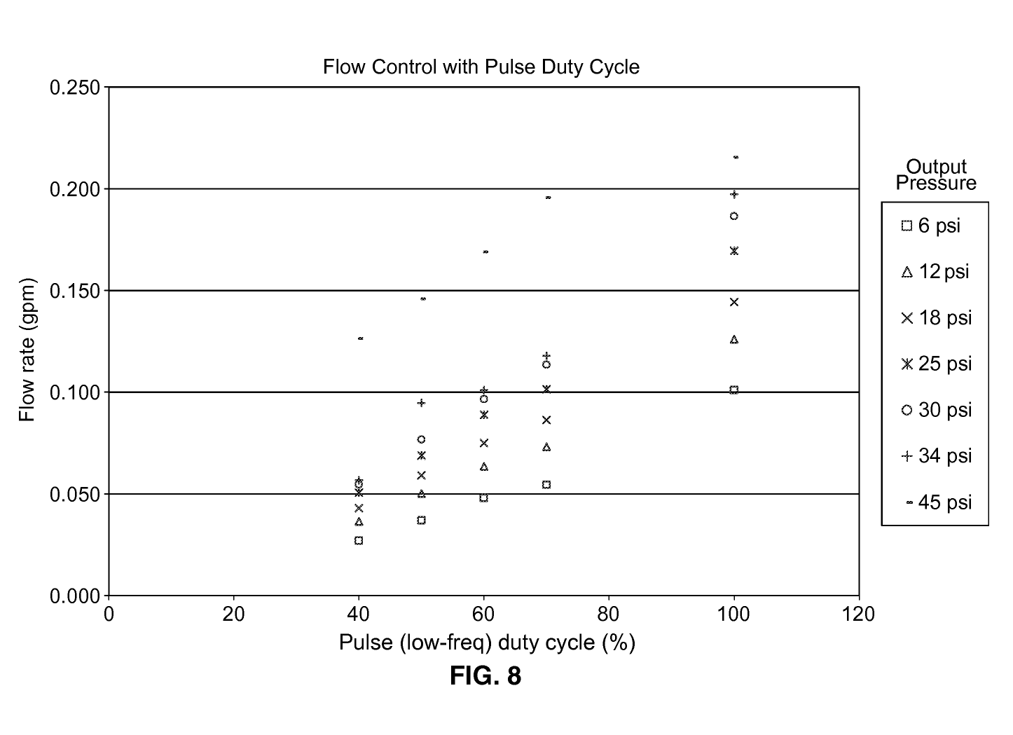

The graph in FIG. 8 shows the resulting flow rates from pulse duty control at various pressures. The various pressures were generated with high frequency duty cycle control.

However, the relative flow rate compared to the relative pulse duty cycle, did not have a 1:1 relationship. This was likely the result of reduced modulation duty cycles causing the valve to open slower than it would with a constant 13.8-volt pulse. The valve also closed slower than it does in the “forward” porting configuration. It was concluded that it may be necessary to decrease the turn-on time by giving a constant 13.8-volt pulse for a specified duration before switching to a modulated signal. Although the slow closing time may not be improved, it would be possible to compensate flow rate by simply offsetting with a duty cycle calibration.

### EXAMPLE 2

The droplet size control was demonstrated using a Kip Series 3 solenoid valve with ¼″ diameter National Pipe Thread (NPT) ports and a 5/32″ diameter orifice that was connected to a liquid (water) reservoir with a constant inlet pressure of 95 psi. The valve was ported opposite of the recommended direction with the pressurized inlet port sealed by the valve poppet. The outlet was connected with a tee to an Omega PV102-10V pressure transducer and to a Spraying Systems flat-fan spray nozzle.

The valve was ported in the reverse direction to avoid the avalanche response for which it was designed. The valve design utilized fluid pressure to open the valve fully with a threshold solenoid current and close fully with a lack of current. Reverse porting avoided the valve's inherent pressure hysteresis characteristics to allow a more controllable outlet response. An additional spring was added behind the valve poppet to increase the effective spring constant and give an additional preload so that the valve would seal against a 95 psi inlet pressure.

The solenoid was powered with a 13.8-volt supply with an IRF7341 field-effect transistor (FET) sinking current to ground. A high-frequency pulse width modulated (PWM) signal was used to control the displacement position (x) of the poppet thereby throttling the fluid flow through the valve. The inductance of the solenoid coil prevented electric current from changing rapidly, and controlled solely by the FET, high-frequency current shut-offs generated voltage spikes on the FET side of the coil. The voltage spikes reversed electric current through the coil, forcing the slightly open valve to close. Because this reverse forcing function made pressure throttling difficult, a Schottky diode was connected parallel to the solenoid to allow excess current to drain after each high-frequency transient event.

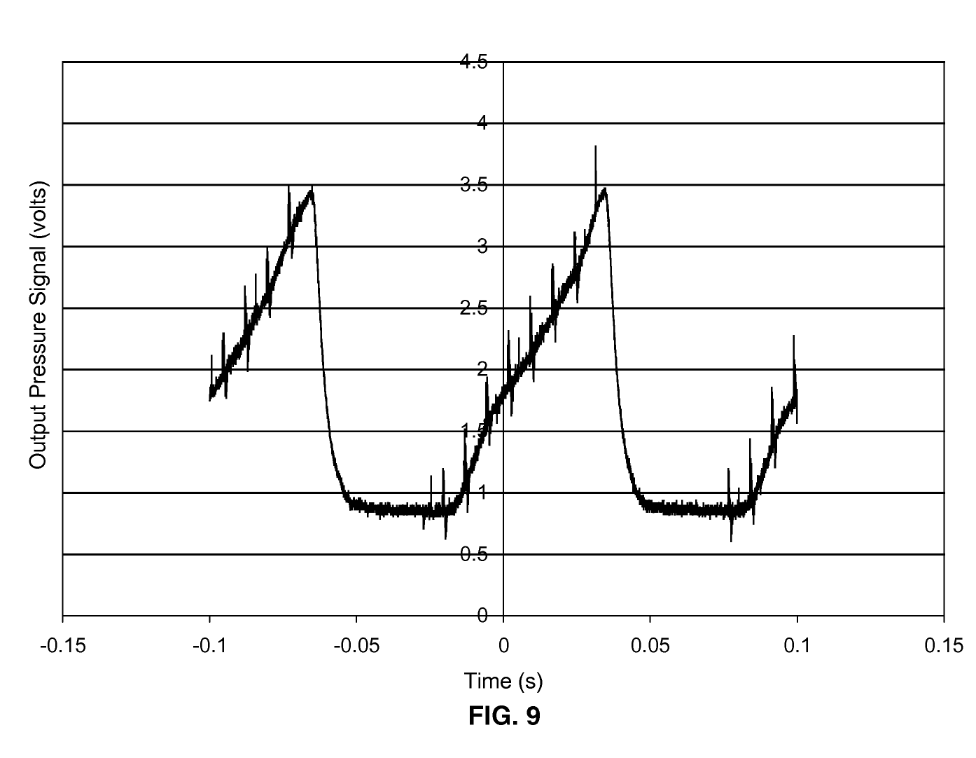

The original drive signal gated the FET with a 10 Hz PWM burst consisting of a modulated ‘on’ period with a 5 kHz square wave and an ‘off’ period in which no current flowed. The use of the bursting signal was observed to result in a ramping of the outlet pressure. The graph in FIG. 9 contains voltage data collected from the pressure transducer by an oscilloscope and demonstrates the ramping outlet pressure.

In order to correct the pressure ramping problem, a more complex drive signal was used. A microcontroller gated the FET with a complex square-wave function consisting of a start-up period (in which the FET was fully turned on), followed by a square wave burst, and then followed by an “off” period. The start-up period was a user specified value in milliseconds. The square-wave burst had a modulation frequency of 5 kHz and a user specified duty cycle. The total duration of the start-up and modulated burst was regulated by a user specified low-frequency pulse duty cycle.

The complex pulse was repeated every 100 milliseconds, so that the setting of the low-frequency duty cycle not only controlled the start-up and burst duration but inversely controlled the off-time between pulses. The resulting waveform from the gated signal was obtained.

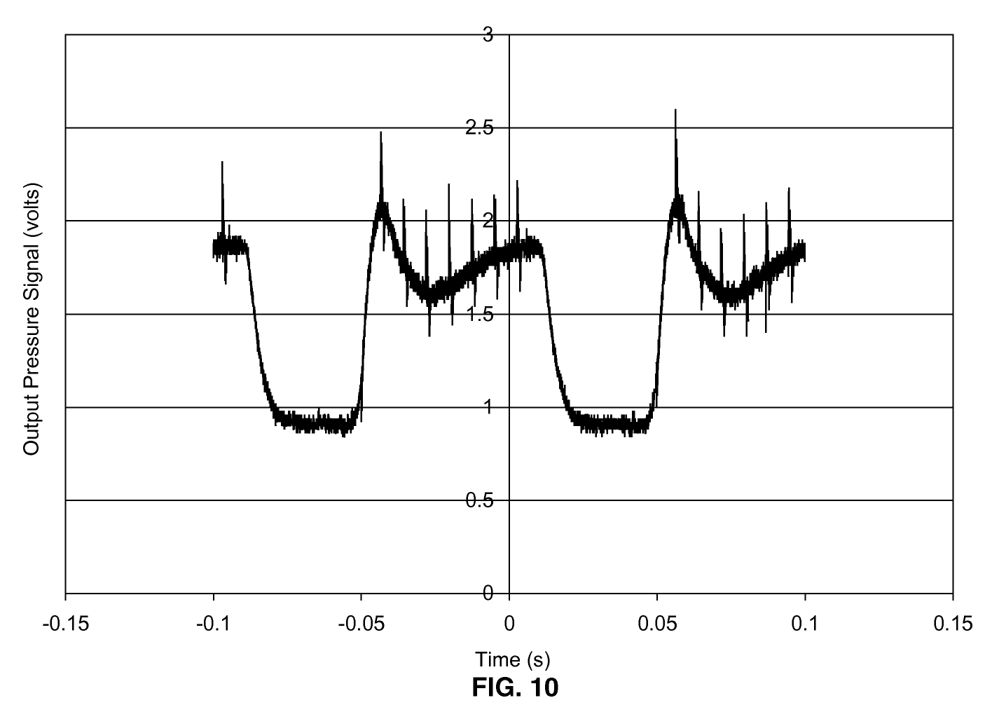

When a start-up blast of constant current was included in the drive signal, the valve was allowed to essentially fully open before the throttling burst signal took effect. The result of the complex burst signal was a more constant outlet pressure as shown in FIG. 10.

The valve was ported with the inlet connected to a pressurized liquid (water) reservoir set to 95 psi. Outlet pressure was monitored with the pressure transducer connected to a Tektronix 3012B oscilloscope, and pressure transducer waveforms were digitally recorded. Average volumetric flow was measured by collecting the spray out of the nozzle and monitoring the time for the nozzle to spray 300 milliliters of water.

The nozzle was spraying 20 inches above the detection laser of a Helos Particle Size Analyzer that measured spray droplets within the range of 18 to 3500 micrometers in diameter. The nozzle was placed so that the detection laser measured particle size two inches from the center of the perpendicular spray fan. Droplet size measurement was automatically triggered when spray started and stopped and was measured for approximately 8 seconds per sample.

Target pressure and flow values were also identified. The solenoid drive signal characteristics of start-up time, modulation duty cycle, and low-frequency pulse duty cycle were modified to yield pressure and flow values near the target values. Three repetitions of two nozzles, a Spraying Systems 8002 and 8006, were tested at four target pressures and six target low-frequency duty cycles. Table 1 shows target pressures and flows, turn on time, modulation duty cycle, and low-frequency pulse duty cycle.

In post-process, transducer voltage waveforms were converted to pressure and a threshold value was selected to declare any pressure above 10 psi as ‘on’. The ‘on’ pressure values within each waveform were then averaged to yield a single pressure value representative of each test.

Particle size cumulative data was windowed to remove noise from inaccuracies in sensor output. 10%, 50%, and 90% cumulative distribution points were calculated by linearly interpolating between the collected data points. Average pressure, flow, and particle size values were calculated from the three repetitions.

Modification of the solenoid drive signal successfully manipulated both outlet pressure and flow. The resulting valve outlet pressure did not remain constant or ramped, but instead fluctuated as shown in FIG. 10. However, the average outlet pressure was consistent between pulses and between trials. Resulting flow was also consistent between trials.

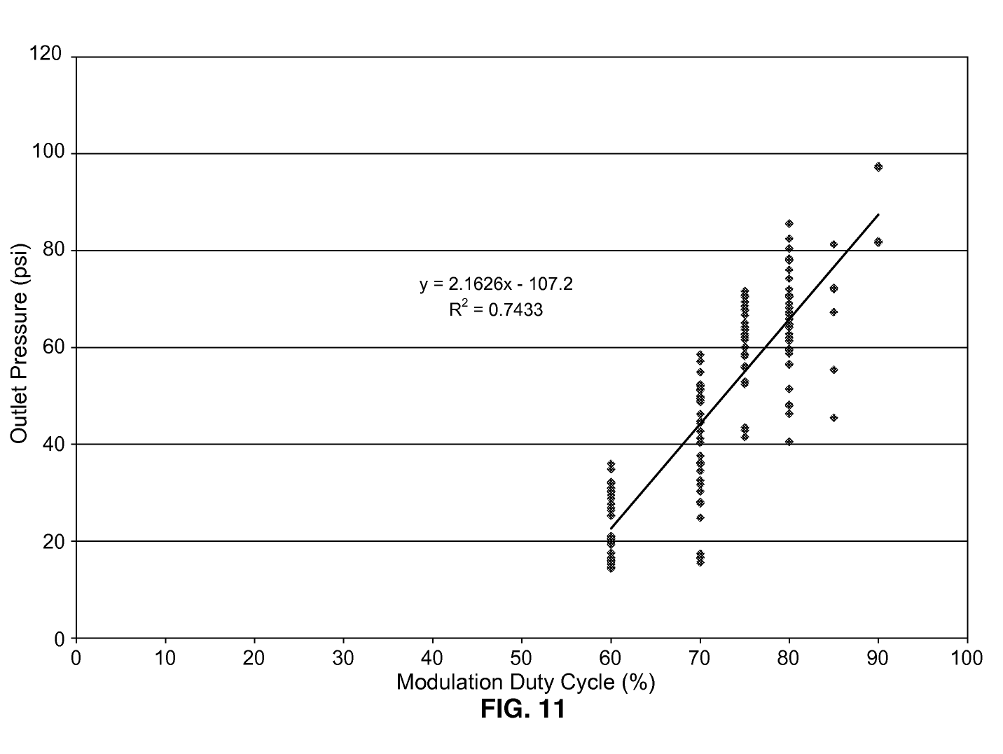

The graph in FIG. 11 shows the resulting output pressure from modulation duty cycle control at various low-frequency duty cycles. The curve demonstrates the relationship between the throttling modulation duty cycle and the outlet pressure.

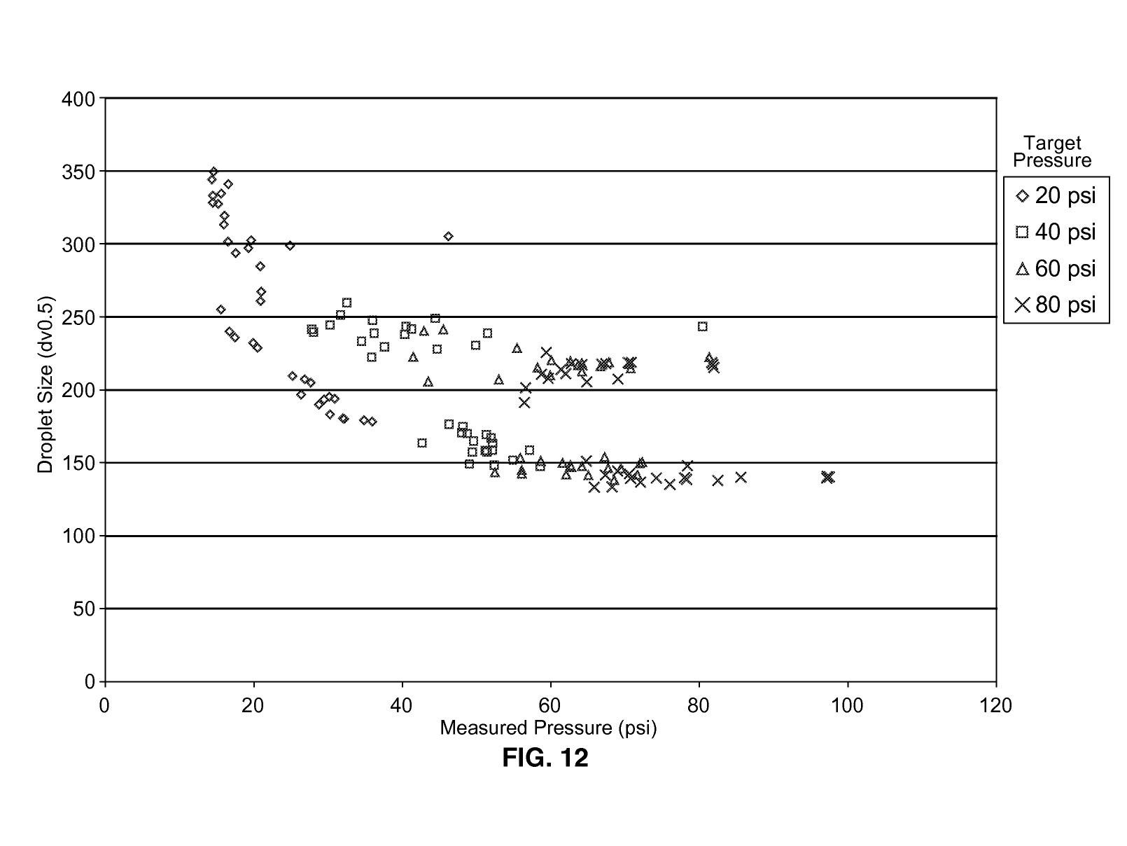

The nozzle pressures at 20 psi, 40 psi, 60 psi and 80 psi were also compared with the average droplet sizes and graphed. The curves in FIG. 12 show the relationship between valve outlet pressure (nozzle pressure) and the average size of droplets produced (50% cumulative volume). This result demonstrates the importance of pressure control to adequately regulate droplet size from the nozzle.

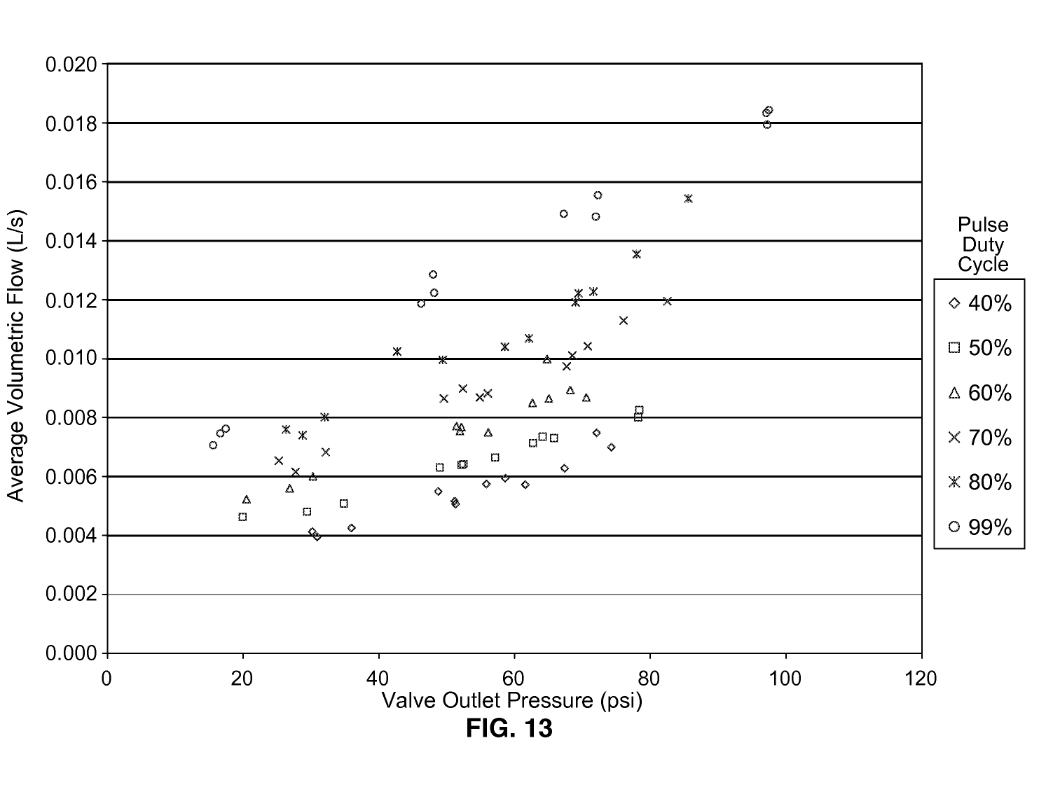

The valve outlet pressure was compared with the average volumetric flow at several pulse duty cycles. As the multiple curves in FIG. 13 demonstrate, the single actuator and 8002 nozzle generated the same pressure with several different flow rates, and the same flow rate at several different pressures. This result demonstrates the effective decoupling of pressure and flow with the single actuator.

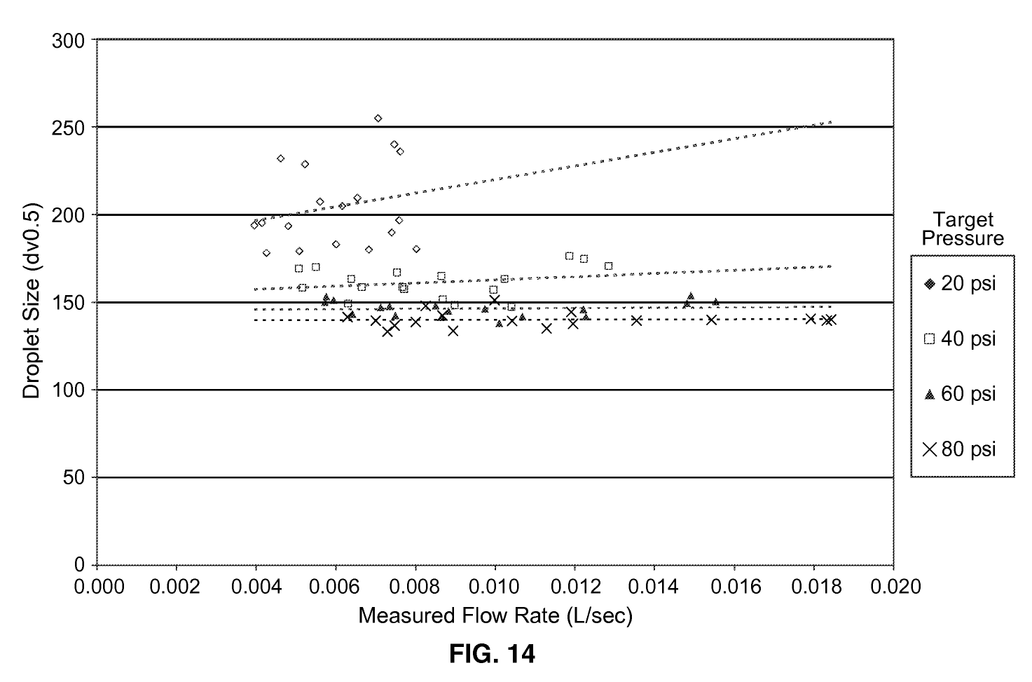

Because average droplet size and nozzle pressure are directly related, and because the solenoid drive manipulation could decouple pressure and flow control, droplet size and flow should be decoupled as well. Indeed, the multiple curves in FIG. 14 demonstrate that the single actuator generated differing flow rates with identical averages in droplet size and differing droplet sizes with identical average flow rates.

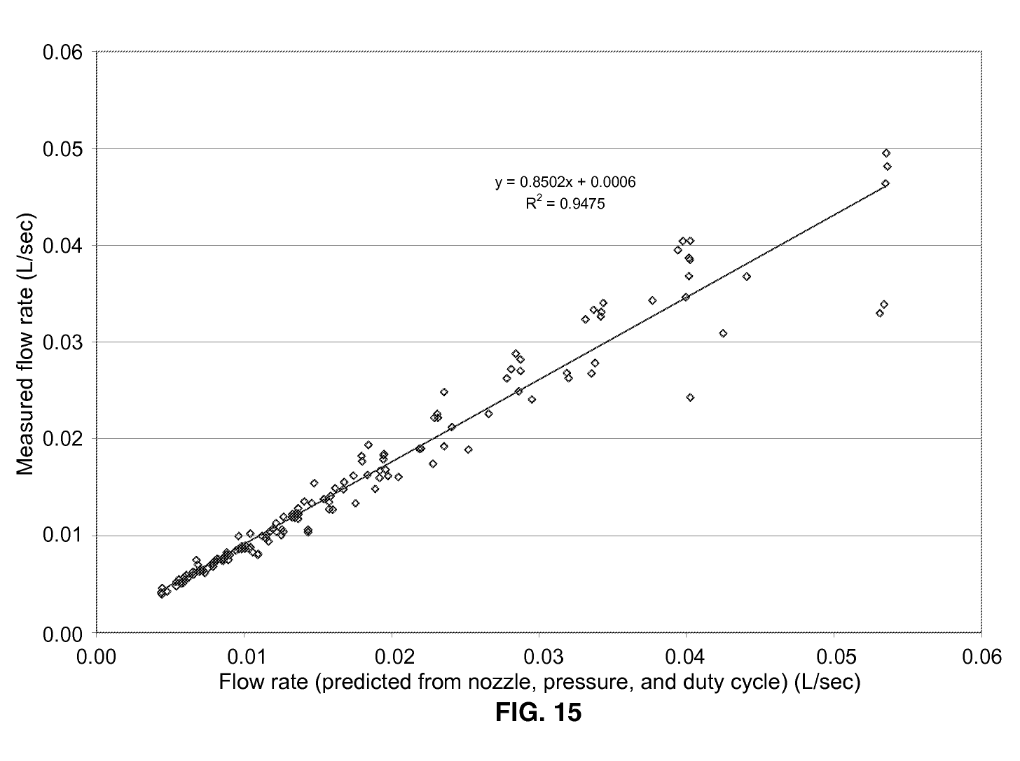

Finally, the measured flow rates were compared with the calculated flow rates predicted from the pulse duty cycle and the nozzle flow-versus-pressure characteristics. As shown in FIG. 15, the relative flow rate to the relative pulse duty cycle did not have a consistent 1:1 relationship. This is probably because the modulated drive signal caused the valve to open slower than it would with a constant 13.8-volt pulse. The valve also closed slower than it does in the “forward” porting configuration. Compensation of lower flow rates may be achieved by simply offsetting with a duty cycle calibration. Additionally, use of a more complex drive circuit may allow for faster opening and closing of the solenoid valve. The solenoid-actuated needle valve with an O-ring seal embodiment shown in FIG. 3 should improve the correlation between the observed flow rates and the flow predicted from the pulse duty cycle.

Accordingly, a direct acting solenoid valve with a single actuator can be used to provide real time control of the flow rate and nozzle pressure through manipulation of the modulating signal. The repeating complex wave form preferably has a burst current for initiating movement of the plunger/poppet; a high frequency pulse width modulation signal for positioning the valve plunger during the lower frequency “on” period and an “off” period. Manipulation of the duration of the high frequency pulse width modulation signal provides control of the pressure drop across the valve and the supply pressure to the nozzle. The duration of the pulse width modulation signal “on” time in relation to the “off” time provides a temporally averaged flow rate.

The present invention provides a flow rate and droplet size control system for an agricultural sprayer apparatus including a spray liquid source, a pump, spray liquid lines, a solenoid valve, a nozzle assembly and a controller. The control system actuates each of the agricultural spray system components such as the spray nozzles to selectively control each of the nozzles or a designated group of the nozzles to deliver sprays with characteristic flow rates, droplet sizes and patterns. By altering the characteristics of the electrical signal from the controller driving the valve, the flowrate of liquid through the valve and the pressure drop across the valve during instantaneous flow can be controlled.

The invention is particularly suited for use with agricultural and industrial sprayers, however, it will be understood that the apparatus and system can be used in any application or system that requires controlled liquid sprays.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Target Pressures And Flows With Solenoid
Drive Signal Characteristics

| | | | | Target | Target |
|---|---|---|---|---|---|
| | Valve Open | Modulation | Pulse | pressure | flow |
| Nozzle | Time (ms) | Duty Cycle | duty cycle | (psi) | (mL/sec) |
| 8002 | 11 | 60 | 40 | 20 | 3.6 |
| 8002 | 11 | 60 | 50 | 20 | 4.5 |
| 8002 | 11 | 60 | 60 | 20 | 5.3 |
| 8002 | 11 | 60 | 70 | 20 | 6.2 |
| 8002 | 11 | 60 | 80 | 20 | 7.1 |
| 8002 | 1 | 70 | 99 | 20 | 8.8 |
| 8002 | 13 | 70 | 40 | 40 | 5.0 |
| 8002 | 13 | 70 | 50 | 40 | 6.3 |
| 8002 | 13 | 70 | 60 | 40 | 7.6 |
| 8002 | 13 | 70 | 70 | 40 | 8.8 |
| 8002 | 13 | 70 | 80 | 40 | 10.1 |
| 8002 | 1 | 80 | 99 | 40 | 12.5 |
| 8002 | 15 | 75 | 40 | 60 | 6.2 |
| 8002 | 15 | 75 | 50 | 60 | 7.7 |
| 8002 | 15 | 75 | 60 | 60 | 9.3 |
| 8002 | 15 | 75 | 70 | 60 | 10.8 |
| 8002 | 15 | 75 | 80 | 60 | 12.4 |
| 8002 | 1 | 85 | 99 | 60 | 15.3 |
| 8002 | 19 | 80 | 40 | 80 | 7.1 |
| 8002 | 19 | 80 | 50 | 80 | 8.9 |
| 8002 | 19 | 80 | 60 | 80 | 10.7 |
| 8002 | 19 | 80 | 70 | 80 | 12.5 |
| 8002 | 19 | 80 | 80 | 80 | 14.3 |
| 8002 | 1 | 90 | 99 | 80 | 17.7 |
| 8006 | 11 | 60 | 40 | 20 | 3.6 |
| 8006 | 11 | 60 | 50 | 20 | 4.5 |
| 8006 | 11 | 60 | 60 | 20 | 5.3 |
| 8006 | 11 | 60 | 70 | 20 | 6.2 |
| 8006 | 11 | 60 | 80 | 20 | 7.1 |
| 8006 | 1 | 70 | 99 | 20 | 8.8 |
| 8006 | 13 | 70 | 40 | 40 | 5.0 |
| 8006 | 13 | 70 | 50 | 40 | 6.3 |
| 8006 | 13 | 70 | 60 | 40 | 7.6 |
| 8006 | 13 | 70 | 70 | 40 | 8.8 |
| 8006 | 13 | 70 | 80 | 40 | 10.1 |
| 8006 | 1 | 80 | 99 | 40 | 12.5 |
| 8006 | 15 | 75 | 40 | 60 | 6.2 |
| 8006 | 15 | 75 | 50 | 60 | 7.7 |
| 8006 | 15 | 75 | 60 | 60 | 9.3 |
| 8006 | 15 | 75 | 70 | 60 | 10.8 |
| 8006 | 15 | 75 | 80 | 60 | 12.4 |
| 8006 | 1 | 85 | 99 | 60 | 15.3 |
| 8006 | 19 | 80 | 40 | 80 | 7.1 |
| 8006 | 19 | 80 | 50 | 80 | 8.9 |
| 8006 | 19 | 80 | 60 | 80 | 10.7 |
| 8006 | 19 | 80 | 70 | 80 | 12.5 |
| 8006 | 19 | 80 | 80 | 80 | 14.3 |
| 8006 | 1 | 90 | 99 | 80 | 17.7 |

What is claimed is:

1. An apparatus, comprising:
an electric solenoid valve; and
electronic circuitry coupled to said electric solenoid valve for actuating the valve in such a manner as to control the liquid flow into an output device from said solenoid valve.

2. An apparatus as recited in claim 1, wherein said output device comprises a spray nozzle.

3. An apparatus as recited in claim 1:
wherein said electronic circuitry generates an electrical signal for driving said valve; and
wherein flowrate of liquid through said valve can be controlled by altering said electrical signal.

4. An apparatus as recited in claim 1:
wherein said electronic circuitry generates an electrical signal for driving said valve; and
wherein pressure drop across said valve can be controlled by altering said electrical signal.

5. An apparatus as recited in claim 1:
wherein said electronic circuitry generates an electrical signal for driving said valve;
wherein flowrate of liquid through said valve can be controlled by altering said electrical signal; and
wherein pressure drop across said valve can be controlled by altering said electrical signal.

6. An apparatus as recited in claim 1:
wherein said signal comprises a complex waveform of a burst current, a high frequency pulse width modulation signal during an on period and an off period.

7. An apparatus as recited in claim 6:
wherein said complex waveform has a repetition rate between approximately 3 Hz and approximately 15 Hz and a high frequency pulse width modulation signal ranging from approximately 5 kHz and approximately 15 kHz.

8. An apparatus as recited in claim 1, said electric solenoid valve further comprising:
means for resisting the movement of a poppet upon actuation of said electric solenoid valve.

9. An apparatus as recited in claim 8:
wherein said means for resisting movement of a poppet upon actuation of the electric solenoid valve comprises a spring.

10. An apparatus as recited in claim 1, said electric solenoid valve further comprising:
a poppet with a poppet head with a conical shaped tip.

11. An apparatus, comprising:
an electronic circuit configured for generating a signal for actuating an electric solenoid valve in such a manner as to simultaneously control the pressure drop across the valve and the rate of liquid flow into an output device.

12. An apparatus as recited in claim 11, wherein said electronic circuit further comprises a computer configured to generate a signal in response to programming.

13. An apparatus as recited in claim 11:
wherein said electronic circuitry generates an electrical signal for driving said valve;
wherein flowrate of liquid through said valve can be controlled by altering said electrical signal; and
wherein pressure drop across said valve can be controlled by altering said electrical signal.

14. An apparatus as recited in claim 11:
wherein said signal comprises a complex waveform of a burst current, a high frequency pulse width modulation signal and an off period.

15. An apparatus as recited in claim 14:
wherein said complex waveform has a repetition rate between approximately 3 Hz and approximately 15 Hz and a high frequency pulse width modulation signal ranging from approximately 5 kHz to approximately 15 kHz.

16. A method for controlling the flowrate and droplet size from a nozzle, comprising:
providing an electric solenoid valve;
providing electronic circuitry coupled to said electric solenoid valve for actuating the valve in such a manner as to control the flow of liquid into a spray nozzle;
generating a signal for driving said electric solenoid valve; and
altering said electrical signal to control the flow of liquid through said nozzle.

17. A method as recited in claim 16, further comprising:
generating an electrical signal for driving said valve;
altering said electrical signal to control the flowrate of liquid through said valve; and
altering said electrical signal to control pressure drop across said valve.

18. A method as recited in claim 16, wherein said altering of an electrical signal comprises:
generating a square wave pulse electrical signal with an on period and an off period for driving said solenoid valve; and
generating a high frequency modulated signal during said on period of said square wave pulse.

19. A method as recited in claim 18, wherein said square wave signal has a frequency between approximately 3 Hz and approximately 15 Hz and a high frequency signal having a frequency between approximately 5 kHz and approximately 15 kHz.

20. A method as recited in claim 16, further comprising:
generating a burst signal prior to an initial generation of said high frequency signal.
